(19) United States
(12) Patent Application Publication
(10) Pub. No.: US 2024/0186605 A1
(43) Pub. Date: Jun. 6, 2024

(54) METHOD FOR RECYCLING LITHIUM SALTS FROM BATTERIES

(71) Applicant: ARKEMA FRANCE, COLOMBES (FR)

(72) Inventor: Gregory SCHMIDT, Pierre-Benite Cedex (FR)

(73) Assignee: ARKEMA FRANCE, COLOMBES (FR)

(21) Appl. No.: 18/285,094

(22) PCT Filed: Mar. 11, 2022
(86) PCT No.: PCT/FR2022/050446

§ 371 Date: Sep. 29, 2023

(30) Foreign Application Priority Data
Mar. 31, 2021 (FR) FR2103312

(51) Int. Cl. H01M 10/54; C22B 3/40; C22B 26/12

(52) U.S. Cl. CPC H01M 10/54; C22B 3/40; C22B 26/12

(57) ABSTRACT

The invention relates to a process for recycling lithium salts contained in the electrolyte of a used lithium battery, which involves supplying an electrolyte stream comprising at least one lithium salt, at least one electrolyte solvent and water; at least one step of extracting the at least one lithium salt by adding a first solvent to the electrolyte stream to recover a phase comprising the at least one lithium salt on one side and a lithium salt-depleted phase on the other side.

### FIELD OF THE INVENTION

The present invention relates to a process for recycling the lithium salts contained in the electrolyte of a used lithium battery.

### TECHNICAL BACKGROUND

Lithium (Li)-containing batteries, such as lithium-ion batteries, are commonly used in electric vehicles and mobile and portable devices.

A lithium-ion or lithium-sulfur battery comprises at least one negative electrode (anode), one positive electrode (cathode), an electrolyte and preferably a separator. The electrolyte generally consists of a lithium salt dissolved in a solvent which is generally a mixture of organic solvents, so as to achieve a good compromise between the viscosity and the dielectric constant of the electrolyte.

The production and disposal of used lithium batteries has become a global concern in terms of environmental protection and the recycling of resources.

The aim of battery recycling is to recover the toxic, rare, precious or economically upgradable metals present in batteries. It also allows a reduction in the amount of batteries found in household waste. Indeed, batteries are a source of accumulation in the environment of certain heavy metals and other chemicals, which may lead to soil contamination and water pollution.

There are two main ways of recycling an Li-ion battery: pyrometallurgical recycling and hydrometallurgical recycling.

Pyrometallurgical recycling uses furnaces and reducing agents to produce metal alloys of Co, Cu, Fe and Ni.

Hydrometallurgical recycling involves the use of aqueous solutions to leach the target metals from the cathode.

In both recycling processes, the lithium salts from the electrolyte, which may represent up to 8% of the cell cost, are recycled little or not at all.

The article by D. L. Thompson et al. “The importance of design in lithium ion battery recycling—a critical review” (Green Chemistry, 2020) relates to Li-ion battery recycling. Said review focuses on the recycling of the elements of the active materials of the electrodes, notably the cathode. It mentions the difficulty of recycling the electrolyte of an Li-ion battery.

The article by Weiguang Lv et al. “Selective recovery of lithium from spent lithium-ion batteries by coupling advanced oxidation processes and chemical leaching processes” (ACS Sustainable Chemistry Engineering, 2020, 8, 5165) describes the recycling of Li-ion batteries via oxidation and chemical leaching processes.

There is a real need to provide a process that allows the lithium salts contained in the electrolyte of a lithium battery to be recovered and recycled efficiently and with sufficient purity.

### SUMMARY OF THE INVENTION

The invention relates primarily to a process for recycling lithium salts contained in the electrolyte of a used lithium battery, which involves:
providing an electrolyte stream comprising at least one lithium salt, at least one electrolyte solvent and water;
at least one step of extracting the at least one lithium salt by adding a first solvent to the electrolyte stream to recover a phase comprising the at least one lithium salt on one side and a lithium salt-depleted phase on the other side.

According to certain embodiments, the at least one lithium salt is chosen from lithium bis(fluorosulfonyl)imide, lithium 2-trifluoromethyl-4,5-dicyanoimidazolate, lithium bis(trifluoromethanesulfonyl)imide, lithium bis(oxalato)borate, lithium difluoroborate, lithium difluorophosphate and mixtures thereof, and preferably the at least one lithium salt is chosen from lithium bis(fluorosulfonyl)imide, lithium 2-trifluoromethyl-4,5-dicyanoimidazolate, lithium bis(trifluoromethanesulfonyl)imide, lithium bis(oxalato)borate, lithium difluoroborate, and mixtures thereof.

According to certain embodiments, the electrolyte solvent is chosen from carbonates, ethers, esters, ketones, alcohols, nitriles, amides, sulfamides and sulfonamides, and mixtures thereof.

According to certain embodiments, the first solvent is chosen from esters, nitriles, ethers, carbonates, carbamates and mixtures thereof.

According to certain embodiments, a second solvent is added during the extraction process, the second solvent preferably being chosen from alkanes, aromatic solvents, chlorinated solvents and mixtures thereof.

According to certain embodiments, the process comprises at least one additional extraction step by adding a second solvent to the phase comprising the at least one lithium salt, the second solvent preferably being chosen from alkanes, aromatic solvents, chlorinated solvents and mixtures thereof.

According to certain embodiments, the process comprises a step of adding a third solvent to the phase comprising the at least one lithium salt to form a mixture and an evaporation step to precipitate the at least one lithium salt.

According to certain embodiments, the process comprises a step of evaporating the phase comprising the at least one lithium salt followed by a step of adding a third solvent to precipitate the at least one lithium salt.

According to certain embodiments, the third solvent is chosen from alkanes, alkenes, aromatics, chlorinated compounds and mixtures thereof.

According to certain embodiments, the stream comprising at least one lithium salt, at least one electrolyte solvent and water is obtained by placing water in contact with a used lithium battery or a portion thereof.

According to certain embodiments, the process involves dissolving the at least one recycled lithium salt in an additional electrolyte solvent.

The present invention makes it possible to meet the need expressed above. More particularly, it provides a process which allows the lithium salts contained in the electrolyte of a lithium battery to be recovered and recycled efficiently and with sufficient purity.

This is accomplished by means of the recycling process of the present invention. More particularly, this is achieved by means of extraction with a first solvent which allows recovery of a phase comprising the intact lithium salt with good purity, allowing it to be used in a lithium battery.

Advantageously, the use of a second solvent allows removal of the amount of residual water entrained by the lithium salt(s) (for example during extraction).

Advantageously, the use of a third solvent allows the lithium salt to be precipitated and recovered as a solid that can be dissolved in a new electrolyte solvent.

The process according to the invention thus allows lithium batteries to be manufactured from recycled lithium salts with good properties and performance.

### DETAILED DESCRIPTION

The invention is now described in greater detail and in a nonlimiting manner in the description that follows.

### Lithium Battery

A lithium battery comprises at least one electrochemical cell, and preferably a plurality of electrochemical cells. Each electrochemical cell includes a negative electrode, a positive electrode and an electrolyte interposed between the negative electrode and the positive electrode.

Each electrochemical cell may also comprise a separator, in which the electrolyte is impregnated.

The electrochemical cells can be assembled in series and/or in parallel in the battery.

The term “negative electrode” means the electrode which acts as the anode when the battery is producing current (i.e. when it is in the process of discharging) and which acts as the cathode when the battery is in the process of charging.

The negative electrode typically comprises an electrochemically active material, optionally an electrically conductive material, and optionally a binder.

The term “positive electrode” means the electrode which acts as the cathode when the battery is producing current (i.e. when it is in the process of discharging) and which acts as the anode when the battery is in the process of charging.

The positive electrode typically comprises an electrochemically active material, optionally an electrically conductive material, and optionally a binder.

The term “electrochemically active material” means a material that is capable of reversibly inserting ions.

The term “electrically conductive material” means a material that is capable of conducting electrons.

The negative electrode of the electrochemical cell may notably comprise, as an electrochemically active material, metallic lithium. This lithium metal may be in essentially pure form, or in the form of an alloy. Among the lithium-based alloys that may be used, examples that may be mentioned include lithium-aluminum alloys, lithium-silica alloys, lithium-tin alloys, Li—Zn, Li₃Bi, Li₃Cd and Li₃SB. Mixtures of the above materials may also be used.

The negative electrode may be in the form of a film or a rod. An example of a negative electrode may comprise a bright lithium film prepared by rolling a lithium strip between rollers.

The positive electrode comprises an electrochemically active material, preferably of the oxide type, and preferably chosen from manganese dioxide (MnO₂), iron oxide, copper oxide, nickel oxide, lithium-manganese composite oxides (for example LiₓMn₂O₄ or LiₓMnO₂), lithium-nickel composite oxides (for example LiₓNiO₂), lithium-cobalt composite oxides (for example LiₓCoO₂), lithium-nickel-cobalt composite oxides (for example LiNi_{1-y}Co_{y}O₂), lithium-nickel-cobalt-manganese composite oxides (for example LiNiₓMn_{y}Co_{z}O₂ with x+y+z=1), lithium-enriched lithium-nickel-cobalt-manganese composite oxides (for example Li₁₊ₓ(NiₓMn_{y}Co_{z})₁₋ₓO₂), lithium-transition metal composite oxides, lithium-manganese-nickel composite oxides of spinel structure (for example LiₓMn_{2-y}Ni_{y}O₄), vanadium oxides, and mixtures thereof.

Preferably, the positive electrode comprises an electrochemically active material which is a lithium-nickel-manganese-cobalt composite oxide with a high nickel content (LiNiₓMn_{y}Co_{z}O₂ with x+y+z=1, abbreviated as NMC, with x>y and x>z), or a lithium-nickel-cobalt-aluminum composite oxide with a high nickel content (LiNi_{x′}Co_{y′}Al_{z′} with x′+y′+z′=1, abbreviated as NCA, with x′>y′ and x′>z′).

Specific examples of these oxides are NMC532 (LiNi_{0.5}Mn_{0.3}Co_{0.2}O₂), NMC622 (LiNi_{0.6}Mn_{0.2}Co_{0.2}O₂) and NMC811 (LiNi_{0.5}Mn_{0.1}Co_{0.1}O₂).

The material of each electrode may also comprise, besides the electrochemically active material, an electrically conductive material, such as a carbon source, including, for example, carbon black, Ketjen© carbon, Shawinigan carbon, graphite, graphene, carbon nanotubes, carbon fibers (for example, vapor-grown carbon fibers or VGCF), non-powdery carbon obtained by carbonization of an organic precursor, or a combination of two or more thereof. Other additives may also be present in the material of the positive electrode, such as lithium salts or inorganic particles of ceramic or glass type, or also other compatible active materials (for example sulfur).

The material of each electrode may also comprise a binder. Nonlimiting examples of binders include linear, branched and/or crosslinked polyether polymer binders (for example polymers based on polyethylene oxide (PEO), or polypropylene oxide (PPO) or a mixture of the two (or an EO/PO copolymer), and optionally comprising crosslinkable units), water-soluble binders (such as SBR (styrene-butadiene rubber), NBR (acrylonitrile-butadiene rubber), HNBR (hydrogenated NBR), CHR (epichlorohydrin rubber), ACM (acrylate rubber)), or fluoropolymer binders (such as PVDF (polyvinylidene fluoride), PTFE (polytetrafluoroethylene), and combinations thereof. Certain binders, such as those that are water-soluble, may also comprise an additive, such as CMC (carboxymethylcellulose).

The separator may be a porous polymer film. By way of nonlimiting example, the separator may consist of a porous film of polyolefin, such as ethylene homopolymers, propylene homopolymers, ethylene/butene copolymers, ethylene/hexene copolymers, ethylene/methacrylate copolymers or multilayer structures of the above polymers.

The electrolyte comprises at least one lithium salt and preferably comprises a plurality of lithium salts. Preferably, the electrolyte comprises at least lithium bis(fluorosulfonyl)imide (LiFSI).

The lithium salt may be chosen from lithium bis(fluorosulfonyl)imide (LiFSI), lithium 2-trifluoromethyl-4,5-dicyanoimidazolate (LiTDI), lithium bis(trifluoromethanesulfonyl)imide (LiTFSI), lithium bis(oxalato)borate (LiBOB), lithium difluoro(oxalato)borate (LiDBOB), lithium difluorophosphate (LiPO₂F₂), lithium tetrafluoroborate (LiBF₄), and mixtures thereof.

According to certain embodiments, the lithium salt is chosen from lithium bis(fluorosulfonyl)imide, lithium 2-trifluoromethyl-4,5-dicyanoimidazolate, lithium bis(trifluoromethanesulfonyl)imide, lithium bis(oxalato)borate, lithium difluoroborate, and mixtures thereof.

According to certain preferred embodiments, lithium hexafluorophosphate (LiPF₆) may be present; in this case, it is found in combination with at least one second lithium salt (preferably chosen from the above list) and advantageously at least lithium bis(fluorosulfonyl)imide (LiFSI).

The electrolyte solvent may be chosen from ethers, esters, ketones, alcohols, nitriles, carbonates, amides, sulfamides and sulfonamides and mixtures thereof.

Among the ethers, mention may be made of linear or cyclic ethers, for instance dimethoxyethane (DME), methyl ethers of oligoethylene glycols containing 2 to 5 oxyethylene units, dioxolane, dioxane, dibutyl ether, tetrahydrofuran and mixtures thereof.

Among the esters, mention may be made of phosphoric acid esters or sulfite esters. Mention may be made, for example, of methyl formate, methyl acetate, methyl propionate, ethyl acetate, butyl acetate, gamma-butyrolactone or mixtures thereof.

Among the ketones, mention may notably be made of cyclohexanone.

Among the alcohols, examples that may be mentioned include ethyl alcohol and isopropyl alcohol.

Among the nitriles, examples that may be mentioned include acetonitrile, pyruvonitrile, propionitrile, methoxypropionitrile, dimethylaminopropionitrile, butyronitrile, isobutyronitrile, valeronitrile, pivalonitrile, isovaleronitrile, glutaronitrile, methoxyglutaronitrile, 2-methylglutaronitrile, 3-methylglutaronitrile, adiponitrile, malononitrile, 1,2,6-tricyanohexane and mixtures thereof.

Among the carbonates, examples that may be mentioned include cyclic carbonates, for instance ethylene carbonate (EC) (CAS: 96-49-1), propylene carbonate (PC) (CAS: 108-32-7), butylene carbonate (BC) (CAS: 4437-85-8), dimethyl carbonate (DMC) (CAS: 616-38-6), diethyl carbonate (DEC) (CAS: 105-58-8), ethyl methyl carbonate (EMC) (CAS: 623-53-0), diphenyl carbonate (CAS: 102-09-0), methyl phenyl carbonate (CAS: 13509-27-8), dipropyl carbonate (DPC) (CAS: 623-96-1), methyl propyl carbonate (MPC) (CAS: 1333-41-1), ethyl propyl carbonate (EPC), vinylene carbonate (VC) (CAS: 872-36-6), fluoroethylene carbonate (FEC) (CAS: 114435-02-8), trifluoropropylene carbonate (CAS: 167951-80-6) or mixtures thereof.

Among the amides, mention may be made of dimethylformamide and N-methylpyrrolidinone.

More preferably, the electrolyte solvent is chosen from EC, EMC, mixtures of EC and EMC, mixtures of EC and DMC, mixtures of EC and DEC, mixtures of EC and DEC, PC, mixtures of EC, DMC and EMC.

Optionally, the electrolyte may comprise one or more polar polymers. The polar polymer preferably comprises monomer units derived from ethylene oxide, propylene oxide, epichlorohydrin, epifluorohydrin, trifluoroepoxypropane, acrylonitrile, methacrylonitrile, esters and amides of acrylic and methacrylic acid, vinylidene fluoride, N-methylpyrrolidone and/or polycation or polyanion polyelectrolytes. When the present electrolyte composition comprises more than one polymer, at least one of them may be crosslinked.

Furthermore, the electrolyte may comprise one or more additives. The additive(s) may be chosen from the group consisting of fluoroethylene carbonate (FEC), vinylene carbonate, 4-vinyl-1,3-dioxolan-2-one, pyridazine, vinylpyridazine, quinoline, vinylquinoline, butadiene, sebaconitrile, alkyl disulfides, fluorotoluene, 1,4-dimethoxytetrafluorotoluene, t-butylphenol, di(t-butyl)phenol, tris(pentafluorophenyl)borane, oximes, aliphatic epoxides, halogenated biphenyls, methacrylic acids, allyl ethyl carbonate, vinyl acetate, divinyl adipate, propane sultone, acrylonitrile, 2-vinylpyridine, maleic anhydride, methyl cinnamate, phosphonates, silane compounds containing a vinyl, and/or 2-cyanofuran.

The at least one lithium salt may be present in the electrolyte in a content of from 0.1% to 50% relative to the weight of the electrolyte.

### Process

The process according to the invention allows the lithium salts present in the electrolyte of a used lithium battery to be recovered and recycled so as to be used again.

The process according to the invention comprises a first step of supplying an electrolyte stream comprising at least one lithium salt, at least one electrolyte solvent and water.

The electrolyte stream is derived from the electrolyte described above. More particularly, the electrolyte stream results from treating (washing) the electrolyte with water or an aqueous stream.

For example, the lithium battery may first be disassembled and optionally crushed.

According to certain embodiments, an evaporation step may be performed prior to washing the electrolyte so as to reduce the solvent content of the electrolyte, for example so as to achieve a lithium salt content of from 5% to 90%. This evaporation may thus be performed at a temperature of from 20 to 150° C., optionally under a reduced pressure of from 0.1 to 800 mbar.

Alternatively, the electrolyte may be directly washed without prior evaporation.

Washing consists in placing water (or an aqueous stream) in contact with the battery or portions thereof (for example the portions of the battery after disassembly or crushing), for the purpose of recovering the lithium salt from the electrolyte. The placing in contact may last from 1 h to 200 h, preferably from 10 h to 100 h, more preferably from 24 h to 72 h. It may be performed, for example, at a temperature of from 5 to 50° C., preferably at a temperature of from 20 to 25° C. (room temperature).

Filtration may be performed after washing to remove any solid particles.

Preferably, the washing is performed with deionized water.

The amount of water added during this step may be between 0.1 and 100 times the battery weight.

According to certain embodiments, an evaporation step may be performed after washing the electrolyte with water, so as to reduce the amount of water in the electrolyte stream. This evaporation may, for example, be performed at a temperature above 30° C., and preferably under a reduced pressure of from 0.1 to 800 mbar.

The dry extract in the electrolyte stream prior to the extraction step may be from 0.1% to 50%, and preferably from 1% to 40%.

The electrolyte stream may have a lithium salt content of from 0.1% to 50%, and preferably from 1% to 40%.

The electrolyte stream may have an electrolyte solvent content of from 5% to 90%, and preferably from 10% to 85%.

The process then includes a step of extracting the lithium salt contained in the electrolyte stream with a first solvent. This step allows the at least one lithium salt to be recovered in the first solvent.

Thus, during this step, a first solvent is added to the electrolyte stream. Following this addition, two different phases are formed; a lithium salt-depleted (aqueous) phase and an (organic) phase comprising the first solvent, the electrolyte solvent and the lithium salt(s). These two phases are then separated, for example by decantation.

According to certain embodiments, the first solvent addition and phase separation step (thus the extraction step) may be performed only once.

According to preferred embodiments, this step may be repeated several times, for example from 2 to 10 times, so as to maximize the amount of lithium salt extracted from the electrolyte stream. To this end, once the first phase separation has been performed, first solvent is added to the separated aqueous phase and the separation step is repeated.

This step may be performed at a temperature of from 5 to 75° C.

At the end of the extraction step(s), the various phases comprising the at least one lithium salt may be pooled. Thus, a phase comprising the at least one lithium salt is obtained on one side and a lithium salt-depleted phase is obtained on the other side. The lithium salt-depleted phase may also comprise various impurities included in the electrolyte.

The first solvent is a preferably polar organic solvent. It is a water-immiscible solvent so as to form two phases when in contact with water.

Preferably, the at least one lithium salt may have a solubility in the first solvent of greater than or equal to 5% by weight relative to the total weight of the sum of salt and solvent. This solubility is measured by placing an excess of lithium salt in the first solvent, and leaving to stir for 48 hours. Subsequent filtration and measurement of the dry extract allow the amount of lithium salt dissolved to be determined.

According to preferred embodiments, the first solvent may be chosen from esters, nitriles, ethers, carbonates, carbamates and mixtures thereof.

Among the esters, mention may be made of ethyl acetate, butyl acetate, isobutyl acetate, ethyl propanoate, propyl propanoate, butyl propanoate and isobutyl propanoate.

Among the nitriles, mention may be made of butyronitrile, isobutyronitrile, pentanenitrile, isopentanenitrile, hexanenitrile and glutaronitrile.

Among the ethers, mention may be made of diethyl ether, dimethoxyethane, dipropyl ether, diisobutyl ether and dibutoxyethane.

Among the carbonates, mention may be made of dibutyl carbonate, diisobutyl carbonate and di-t-butyl carbonate.

Among the carbamates, mention may be made of 1,3-diisopropylurea, 1,3-dibutylurea and 1,3-diisobutylurea.

According to preferred embodiments, the first solvent is an ester or a nitrile.

The mass ratio between the electrolyte stream and the first solvent, for each extraction, may range from 0.1 to 50, and preferably from 1 to 40.

A second solvent, different from the first solvent, may be used. The purpose of the second solvent is to remove the water entrained by the lithium salts in the first solvent.

According to certain embodiments, the second solvent may be added during extraction. In this case, the phase comprising the at least one lithium salt is a mixture of the first and second solvents. When several successive extractions are performed, it is possible to envisage that some of them are performed with the first solvent only, and others with the mixture of the first and second solvents. For example, one or more extractions may be performed with the first solvent, followed by one or more extractions with a mixture of the first and second solvents. In this case, during the or each extraction, the mass ratio of second solvent relative to the first solvent may be from 0.1 to 5, and preferably from 0.15 to 4.

Alternatively, after one or more extractions with the first solvent, one or more further extractions may be performed with the second solvent only. In this case, the second solvent is added to the phase comprising the lithium salt resulting from the extraction(s) with the first solvent, so as to separate out and remove any residual water present in this phase. The mass ratio of second solvent relative to the phase in which it is added may be from 0.1 to 5, and preferably from 0.15 to 4. According to certain embodiments, only one additional extraction is performed.

According to preferred embodiments, an additional extraction may be repeated several times, for example from 2 to 10 times (in the same way as presented above for the case of extraction with the first solvent).

In the case where one or more additional extractions are performed, the organic phases recovered after these extractions (comprising the at least one lithium salt) are pooled and mixed.

Preferably, the second solvent is miscible with the first solvent and immiscible with water. It is also preferable for the second solvent to be an organic solvent, and preferably apolar. This solvent is preferably chosen from alkanes, aromatic solvents, chlorinated solvents and mixtures thereof.

Among the alkanes, mention may be made of pentane, hexane, heptane, cyclohexane, decane and dodecane.

Among the aromatic solvents, mention may be made of toluene and xylenes.

Among the chlorinated solvents, mention may be made of dichloromethane, 1,2-dichloroethane, dichlorobenzene and trichlorobenzene.

According to certain embodiments, the process may also comprise a step of evaporating the phase comprising the at least one lithium salt. This step allows the amount of water contained in this phase to be reduced to a mass content of less than or equal to 15 000 ppm, and preferably less than or equal to 10 000 ppm. This step also allows the amount of solvent (first and/or second solvent) in the phase comprising the at least one lithium salt to be reduced. For example, the solution resulting from this evaporation step may have a solvent (first and/or second) content of less than or equal to 10%, and preferably less than or equal to 5%.

This evaporation step may be performed at a temperature of from 10 to 90° C., and preferably from 20 to 80° C.

In addition, this step may preferably be performed under reduced pressure, i.e. from 0.1 to 800 mbar.

The dry extract in the electrolyte stream after evaporation may be from 10% to 75%, and preferably from 5% to 60%.

At the end of this evaporation step, a third solvent may be added to the solution resulting from the evaporation. The purpose of this addition is to precipitate the at least one lithium salt from this solution. The addition may be made in a proportion of 0.5 to 50, and preferably 1 to 25, relative to the mass of the solution resulting from the evaporation.

The third solvent is preferably an organic solvent, and even more preferably is apolar. It is preferably a solvent which does not dissolve the at least one lithium salt. The third solvent preferably has a higher boiling temperature than that of the first solvent. Preferably, the third solvent is chosen from alkanes, alkenes, aromatic solvents, chlorinated compounds and mixtures thereof.

Preferably, the third solvent is different from the second solvent and also preferably the third solvent is a solvent with a high boiling point, for example a boiling point above 105° C.

Among the alkanes, examples that may be mentioned include decane and dodecane.

Among the aromatic solvents, examples that may be mentioned include toluene and xylenes.

Among the chlorinated solvents, examples that may be mentioned include dichlorobenzene and trichlorobenzene.

According to preferred embodiments, the third solvent is a chlorinated compound, and also preferably the third solvent is chlorobenzene.

Alternatively, the third solvent may be added to the phase comprising the at least one lithium salt. In this case, the solvent mixture (first and/or second and third) may then be evaporated off so as to remove the first and/or second solvent and to provide a solution of the at least one lithium salt in the third solvent. This embodiment is advantageous in cases where the third solvent has a higher boiling point than the boiling point of the first and/or second solvent. Preferably, this difference is at least 15° C., and preferably at least 20° C. For example, this difference may be from 15 to 20° C., or from 20 to 25° C., or from 25 to 30° C., or from 30 to 35° C. or from 35 to 40° C. or more.

This step may be performed at a temperature of from 10 to 90° C., and preferably from 20 to 80° C.

Furthermore, this step is preferably performed under reduced pressure, namely from 0.1 to 800 mbar.

The third solvent may be added to the phase comprising the at least one lithium salt in an amount (or mass ratio) of from 5% to 75%, and preferably from 10% to 65%.

The at least one lithium salt may be precipitated out, preferably from the third solvent.

The precipitated lithium salt may, for example, be recovered by filtration. In certain cases, the filtration may be followed by rinsing and/or drying of the solid obtained.

Thus, the at least one recovered lithium salt may subsequently be recycled and used as an electrolyte in a lithium battery. To this end, the at least one recovered lithium salt may be added to an (additional) electrolyte solvent which may be as defined above.

As an alternative to using a third solvent to precipitate out the at least one lithium salt, it is possible in certain cases, notably when the first solvent is identical to the desired (additional) electrolyte solvent (such as a carbonate), to continue the evaporation step (of the phase comprising the at least one lithium salt) and to use the solution obtained after evaporation for the manufacture of a lithium battery and more particularly for the electrolyte of a lithium battery. For this purpose, it is preferable to continue the evaporation so as to obtain a solution with a water content by mass of less than or equal to 300 ppm, and preferably less than or equal to 100 ppm. In this case, this content may be less than or equal to 300 ppm; or may be less than or equal to 250 ppm; or may be less than or equal to 200 ppm; or may be less than or equal to 150 ppm; or may be less than or equal to 100 ppm; or may be less than or equal to 50 ppm.

The lithium salt recycling process according to the invention allows lithium salts to be efficiently recovered from the electrolyte of a lithium battery and reused for manufacturing lithium batteries. Batteries made from recycled lithium salts according to the invention have good properties and performance, comparable to the properties of a battery made from an electrolyte comprising new (non-recycled) lithium salts. Batteries made from recycled lithium salts according to the invention have, for example, a power, and/or a service life and/or resistance that are comparable to those of a battery made from an electrolyte comprising new lithium salts.

### EXAMPLES

The following examples illustrate the invention without limiting it.

### Example 1—Comparative

An Li-ion battery (200 mAh NMC622/graphite pouch cell) comprising 978 μL of an electrolyte having the following composition is used: 1 mol/L LiPF₆ in a mixture of ethylene carbonate and ethyl methyl carbonate with a volume ratio of 3:7 supplemented with 1% by weight of fluoroethylene carbonate and 1% by weight of vinyl carbonate.

After 1500 charging/discharging cycles at 1C, this battery was opened and placed in contact with 1 L of deionized water for 48 hours at 25° C. The solution was filtered and concentrated under vacuum at 45° C. to a solids content of 40%. The solution obtained is non-homogeneous, with a solid part and a liquid part. This solution was extracted with 4×20 g of butyl acetate.

¹⁹F NMR analysis showed no PF⁶⁻ anion in the organic solution obtained.

Cationic ion chromatography analysis did not show the presence of any lithium cations.

### Example 2—According to the Invention

An Li-ion battery (200 mAh NMC622/graphite pouch cell) comprising 978 μL of an electrolyte having the following composition is used: 0.9 mol/L LiFSI, 0.05 mol/L LiTDI and 0.05 mol/L LiPF₆ in a mixture of ethylene carbonate and ethyl methyl carbonate with a volume ratio of 3:7 supplemented with 2% by weight of fluoroethylene carbonate.

After 1500 charging/discharging cycles at 1C, this battery was opened and placed in contact with 1 L of deionized water. The resulting solution was then filtered and concentrated at 45° C. under reduced pressure to a solids content of 40%.

This concentrated solution was extracted with butyl acetate (4×20 g). The organic phases were pooled and concentrated under reduced pressure at 50° C. to a solids content of 45%. The water content of the concentrate obtained was 5232 ppm.

Chlorobenzene (200 g) was then added to the preceding solution and the butyl acetate was removed by evaporation under reduced pressure at 60° C. A white solid was formed and recovered by filtration, rinsed with chlorobenzene (3×50 g) and dried under vacuum. ¹⁹F NMR analysis gave the following mass composition for the solid obtained: 92.4% LiFSI and 7.6% LiTDI. Ion chromatography analysis shows 9 ppm of fluoride and 24 ppm of sulfate.

### Example 3—According to the Invention

The solid from Example 2 was then used as starting material to manufacture a new electrolyte having the following composition: 0.9 mol/L LiFSI, 0.05 mol/L LiTDI and 0.05 mol/L LiPF₆ in a mixture of ethylene carbonate and ethyl methyl carbonate with a volume ratio of 3:7 supplemented with 2% by weight of fluoroethylene carbonate. Thus, an Li-ion battery (200 mAh NMC622/graphite pouch cell) containing 979 μL of this recycled electrolyte was charged and discharged for 1500 cycles at a duty cycle of C at a temperature of 25° C. The cycling results for a fresh (non-recycled) electrolyte and the recycled electrolyte are compared in the table below:

TABLE 1

| | Fresh | Recycled |
|---|---|---|
| | electrolyte | electrolyte |
| Irreversible capacity (mA · h) | 17.5 | 17.8 |
| Polarization (mV) | 93 | 90 |
| Initial capacity (mA · h) | 147.3 | 144.9 |
| Capacity at 1000 cycles (mA · h) | 131.5 | 129.6 |
| Capacity loss at 1000 cycles (%) | 10.7 | 10.6 |

As shown in the above table, the recycled electrolyte performs similarly to the fresh electrolyte in terms of irreversible capacity, polarization and capacity loss. The initial capacity is different due to the variability in the manufacture of this type of battery. These results confirm that the recycling process according to the invention allows the production of lithium salts that are of sufficient purity for reuse as starting materials.

1. A process for recycling lithium salts contained in the electrolyte of a used lithium battery, the process comprising:
supplying an electrolyte stream comprising at least one lithium salt, at least one electrolyte solvent and water; and
at least one step of extracting the at least one lithium salt by adding a first solvent to the electrolyte stream to recover a phase comprising the at least one lithium salt on one side and a lithium salt-depleted aqueous phase on the other side.

2. The process as claimed in claim 1, in which, after adding the first solvent, the phase comprising the first solvent, the electrolyte solvent and the at least one lithium salt is recovered on one side and a lithium salt-depleted aqueous phase is recovered on the other side.

3. The process as claimed in claim 1, in which the at least one lithium salt is chosen from lithium bis(fluorosulfonyl)imide, lithium 2-trifluoromethyl-4,5-dicyanoimidazolate, lithium bis(trifluoromethanesulfonyl)imide, lithium bis(oxalato)borate, lithium difluoroborate, lithium difluorophosphate and mixtures thereof.

4. The process as claimed in claim 1, in which the at least one lithium salt is lithium bis(fluorosulfonyl)imide.

5. The process as claimed in claim 1, in which the electrolyte solvent is chosen from carbonates, ethers, esters, ketones, alcohols, nitriles, amides, sulfamides and sulfonamides, and mixtures thereof.

6. The process as claimed in claim 1, in which the first solvent is chosen from esters, nitriles, ethers, carbonates, carbamates and mixtures thereof.

7. The process as claimed in claim 1, in which a second solvent is added during the extraction process.

8. The process as claimed in claim 1, comprising at least one additional extraction step by adding a second solvent to the phase comprising the at least one lithium salt.

9. The process as claimed in claim 1, comprising a step of adding a third solvent to the phase comprising the at least one lithium salt to form a mixture and an evaporation step to precipitate the at least one lithium salt.

10. The process as claimed in claim 1, comprising a step of evaporating the phase comprising the at least one lithium salt followed by a step of adding a third solvent to precipitate the at least one lithium salt.

11. The process as claimed in claim 9, in which the third solvent is chosen from alkanes, alkenes, aromatics, chlorinated compounds and mixtures thereof.

12. The process as claimed in claim 1, in which the stream comprising at least one lithium salt, at least one electrolyte solvent and water is obtained by placing water in contact with a used lithium battery or a portion thereof.

13. The process as claimed in claim 1, comprising the dissolution of the at least one recycled lithium salt in an additional electrolyte solvent.

14. The process as claimed in claim 1, in which the at least one lithium salt is chosen from lithium bis(fluorosulfonyl)imide, lithium 2-trifluoromethyl-4,5-dicyanoimidazolate, lithium bis(trifluoromethanesulfonyl)imide, lithium bis(oxalato)borate, lithium difluoroborate, and mixtures thereof.

15. The process as claimed in claim 7, wherein the second solvent is chosen from alkanes, aromatic solvents, chlorinated solvents and mixtures thereof.

16. The process as claimed in claim 8, wherein the second solvent is chosen from alkanes, aromatic solvents, chlorinated solvents and mixtures thereof.
